(19) United States
(12) Patent Application Publication
(10) Pub. No.: US 2009/0188921 A1
(43) Pub. Date: Jul. 30, 2009

(54) Combined vented container and collection bag and associated method

(76) Inventor: Mark Ball, Gambrills, MD (US)

Correspondence Address: ASHKAN NAJAFI, P.A., 6817 SOUTHPOINT PARKWAY, SUITE 2301, JACKSONVILLE, FL, 32216, US

(21) Appl. No.: 12/321,041

(22) Filed: Jan. 15, 2009

Related U.S. Application Data
(60) Provisional application No. 61/062,550, filed on Jan. 28, 2008.

(51) Int. Cl. B65F 1/06; B65F 1/10

(52) U.S. Cl. 220/495.04; 220/495.06

(57) ABSTRACT

A combined vented container and collection bag for use during debris collecting, transporting and removal procedures includes a portable container having a closed bottom end and an open top end. The container has an outer surface continuously spanning along a circumference of the container such that a cavity is formed intermediately of the bottom and top end. The top end has a top rim continuously extending about the entire perimeter. The outer and inner surfaces of the container have several vent openings to allow air to enter and exit the container. Also, a manually-operable mechanism is provided for regulating air flow into and out from the container.

### CROSS REFERENCE TO RELATED APPLICATIONS

This application claims the benefit of U.S. Provisional Application No. 61/062550, filed Jan. 28, 2008, the entire disclosures of which are incorporated herein by reference.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to collection receptacles and, more particularly, to a combined vented container and collection bag for use during debris collecting, transporting and removal procedures.

2. Prior Art

For many of us, the notion of raking and removing fallen leaves does not conjure up fond thoughts. It is tedious, back-breaking work that never seems to end in the fall and winter months. The fact that different species of trees drop their leaves at different times means raking leaves can be a weekly chore in many areas.

Once the leaves are raked into nice, neat piles the next step is to get the leaves from the ground into a garbage bag. There are many methods to achieve this goal. One method requires the user to lay a garbage bag on the ground near the pile. The user then stands with each foot on a corner of the bag and uses a hand to lift the top portion of the bag into the air, making a crude triangle opening. The user then awkwardly tries to use his other hand to rake the pile into the bag. Most often, a user will simply drag a large garbage can to the leaf pile. The user then puts a garbage bag in the can and fills the bag with the leaves. The problem with this method comes when the user tries to remove the filled bag from the can. Not only is the bag heavy with the weight of the leaves, but the user is also working against the vacuum suction created when he tries to remove the bag from the can. This force makes it very difficult and strenuous to remove the bag. Another downside to this method is that many bags are not filled as full as they could be as the vacuum created decreases the bags capacity.

U.S. Pat. No. 5,388,717 to Le Vasseur discloses a vented trash can that consists of a container having an open top for the insertion and removal of a plastic trash bag. A component is for allowing air to enter the container under the plastic trash bag when removing the plastic trash bag from the container. The normal vacuum in the container is now broken and the plastic trash bag can slide out rather than be suctioned against the inside of the container. Unfortunately, this prior art reference does not disclose an apparatus with a plurality of vents formed along a perimeter of the container.

U.S. Pat. No. 6,736,281 to Joseph discloses a vacuum-release waste receptacle designed to prevent vacuum adherence of a plastic liner disposed within the present receptacle upon removal of the liner. The present invention provides a waste receptacle including a plurality of air baffles formed on the inner sidewalls of the receptacle and projecting inwardly into the interior space of the receptacle and to its bottom wall. The air baffles are fabricated to a predetermined dimension, which is calculated to provide an indentation of sufficient depth in the filled plastic liner to create air conduits between the plastic liner, the air baffles, and the inner surface of the receptacle. The air conduits permit the ingress of atmospheric air into the receptacle providing for vacuum-release of the plastic liner upon its removal. Unfortunately, this prior art reference does not disclose the ability to selectively adapt the vents between open and closed positions.

U.S. Pat. No. 4,294,379 to Bard discloses an apparatus for holding a flexible, collapsible trash liner. A rigid upward vented trash receptacle receives a flexible, collapsible, trash liner and includes along the side walls of the upward vented trash receptacle a plurality of axially aligned and peripherally positioned hollow tubes which are interior to or part of (molded into) the vented trash receptacle's internal walls and open at both ends which terminate approximately 1″ interior to the top and bottom of the upward vented trash receptacle. Unfortunately, this prior art reference does not have the ability to selectively open and close the vents via manual tabs.

Accordingly, a need remains for a combined vented container and collection bag in order to overcome the above-noted shortcomings. The present invention satisfies such a need by providing a device that is convenient and easy to use, is durable yet lightweight in design, is versatile in its applications, and provides for use during debris collecting, transporting and removal procedures.

### BRIEF SUMMARY OF THE INVENTION

In view of the foregoing background, it is therefore an object of the present invention to provide an apparatus for use during debris collecting, transporting and removal procedures. These and other objects, features, and advantages of the invention are provided by a combined vented container and collection bag.

A combined vented container and collection bag for use during debris collecting, transporting and removal procedures may include a portable container preferably having a closed bottom end and an open top end. The container may further preferably have an outer surface continuously spanning along a circumference of the container such that a cavity is formed intermediately of the bottom and top end. The top end preferably has a top rim continuously extending about the entire perimeter. The container may come in a variety of shapes such as cylinders or rectangles and may also be manufactured in a variety of sizes. The apparatus may be used in the home or outdoors to replace any existing collection can. For example, the present invention may be employed to collect yard waste, laundry, kitchen waste, bathroom waste, etc.

A collection bag may be removably positioned within the cavity in such a manner that a top edge of the collection bag remains continuously conjoined with the top rim of the container. The bag may fold over the top rim of the container and may be held in place by allowing ambient air to flow through the container. In particular, the present invention may include a mechanism to permit ambient air to freely ingress and egress through the outer surface, and thereby generate an external force that pushes inwardly against the collection bag while seated within the cavity.

The external force preferably maintains the collection bag at a substantially stable position by assisting to prohibit the top edge of the collection bag from prematurely disengaging the top rim as debris is deposited into the collection bag and further by assisting to prohibit the collection bag from undesirably clinging to an inner surface of the container during removal from the cavity. The incoming and outgoing air flow helps maintain the bag situated within the cavity by preventing restrictive forces from building within the cavity, thereby making it easier for bag removal by the user.

The ambient air ingressing and egressing mechanism may include a plurality of vents formed in the container and passing from the outer surface to the inner surface. The mechanism may further include a plurality of access panels slidably coupled to the vents respectively. The access panels preferably have a lever statically mated thereto and terminating exterior of the outer surface such that the levers are accessible from an exterior of the container. The access panels may be configured in such a manner that the vents may be toggled between open and closed positions when the access panels are reciprocating along corresponding travel paths respectively. The travel paths may be intercalated between the inner and outer surfaces of the container. The access panels may be opened or closed to assist in regulating air flow passes through the container and thereby ensure the bag does not disengage the top rim as well as assist in easily removing the bag from the cavity.

The vents may include a plurality of apertures separated into a plurality of separated clusters spaced along the outer surface of the container. A plurality of face plates are preferably intercalated between the inner and outer surfaces of the container. The face plates may be aligned with corresponding clusters and further may be anchored to the levers respectively. A plurality of rectilinear slots formed in the container may be adjoined to the clusters respectively; wherein each of the levers traverses a corresponding one of the slots and remains spaced from the clusters respectively. The travel paths may be defined along associated longitudinal lengths of the slots respectively.

The ambient air ingressing and egressing mechanism may further include a plurality of elongated arms preferably having opposed ends directly and statically interconnected to adjacent ones of the access panels respectively, such that the arms are arranged at an end-to-end pattern along a circumference of the container. The arms may be intercalated between the inner and outer surfaces of the container. Interconnected groups of the arms and the levers may uniformly shift along a curvilinear travel path defined along the circumference of the container when a first one of the levers is displaced along one of the corresponding travel paths. The interconnected ones of the access panels uniformly shift in sync when the interconnected arms shift in sync and thereby adapt the vents between the open and closed positions respectively. Further, the invention may feature a lid pivotally coupled to the top rim of the container.

The present invention may further include a method for using a vented container and collection bag during debris collecting, transporting and removal procedures. Such a method may include the chronological steps of first providing a portable container that preferably has a closed bottom end and an open top end. The container further preferably has an outer surface continuously spanning along a circumference of the container such that a cavity is formed intermediately of the bottom and top ends. The top end preferably has a top rim continuously extending about an entire perimeter thereof.

A second step of the method may include providing and removably positioning a collection bag within the cavity in such a manner that a top edge of the collection bag remains continuously conjoined with the top rim of the container. A third step may include permitting ambient air to freely ingress and egress through the outer surface, and thereby generating an external force that pushes inwardly against the collection bag while seated within the cavity. Lastly, the external force will maintain the collection bag at a substantially stable position by assisting to prohibit the top edge of the collection bag from prematurely disengaging the top rim as debris is deposited into the collection bag and further by assisting to prohibit the collection bag from undesirably clinging to an inner surface of the container during removal from the cavity.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a perspective view showing a combined vented container and collection bag having a foot-receiving hole, in accordance with the present invention;

FIG. 2 is a perspective view of FIG. 1 wherein the lid is removed from the container;

FIG. 3 is a side elevational view showing the internal components of the air flow regulating mechanism along with the collection positioned inside the container;

FIGS. 3a-3b are enlarged call-out views showing the interrelationship between the arms, tabs and vents, respectively;

FIG. 4 is a perspective view showing the end-to-end relationship of the arms and tabs;

FIG. 5 is a perspective view showing an alternate embodiment of the combined vented container and collection bag;

FIG. 6 is a perspective view of FIG. 5 wherein the lid is removed from the container; and

FIG. 7 is a side elevational view of FIG. 5.

Those skilled in the art will appreciate that the figures are not intended to be drawn to any particular scale; nor are the figures intended to illustrate every embodiment of the invention. The invention is not limited to the exemplary embodiments depicted in the figures or the shapes, relative sizes or proportions shown in the figures.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

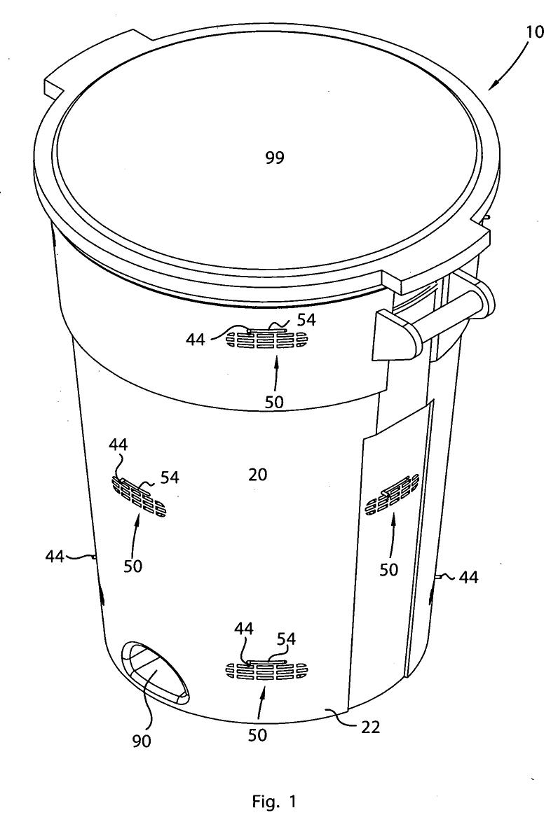

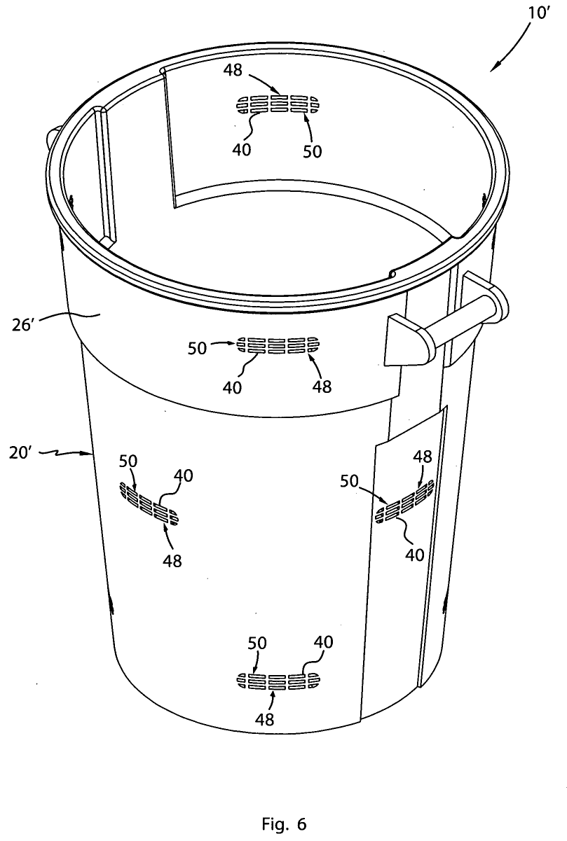

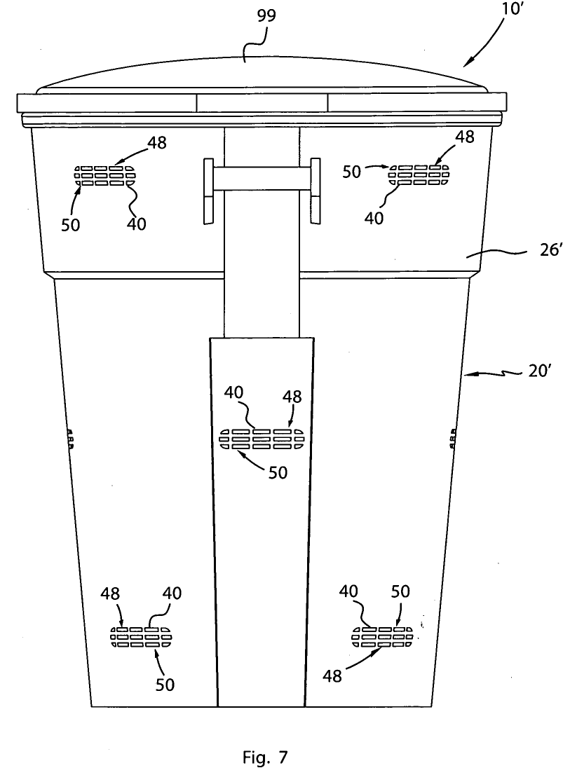

The apparatus of this invention is referred to generally in FIGS. 1-7 by the reference numeral 10 and is intended to provide a combined vented container and collection bag. It should be understood that the combined vented container and collection bag apparatus 10 may be used to assist a user to deposit various items into the collection bag while preventing a vacuum from forming between the collection bag and inner wall of the container.

Thus, one skilled in the art will appreciate the present invention is not limited to any particular application, thereby permitting interior and exterior applications. The apparatus 10 may be used in the home or outdoors to replace any existing collection can. Notably, one embodiment 10 of the present invention is illustrated in FIGS. 1-4, which includes a foot-receiving hole 90 to assist the user when removing the collection bag 32. Of course, another embodiment of the present invention may not have the foot-receiving hole.

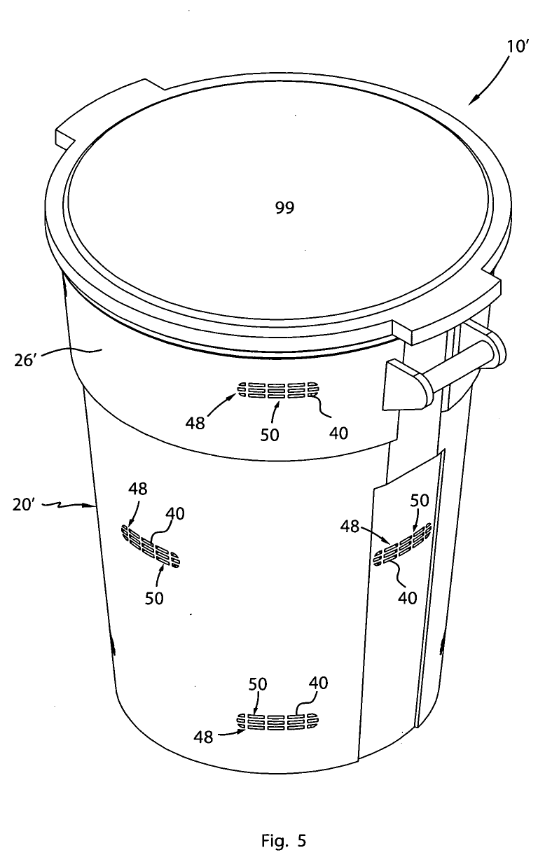

Referring to FIGS. 5-7, one embodiment 10′ of the present invention includes container 20′ provided with vents 40. A lid 99 may be removably attached to container 20′. The vents 40 may include a plurality of apertures 48 separated into a plurality of separated clusters 50 spaced along the outer surface 26′ of the container 20′. Such a container 20′ may include a foot-receiving hole, similar to the foot-receiving hole 90 of FIG. 1.

Now referring to FIGS. 1-4, another embodiment 10 of the present invention may include a combined vented container 20 and collection bag 32 for use during debris collecting, transporting and removal procedures may include a portable container 20 preferably having a closed bottom end 22 and an open top end 24. The container 20 may preferably have an outer surface 26 continuously spanning along a circumference of the container such that a cavity 28 is formed intermediately of the bottom 22 and top 24 ends. The top end 24 preferably has a top rim 30 continuously extending about the entire perimeter of the container. Of course, the container 20 may come in a variety of shapes such as cylinders or rectangles and may also be manufactured in a variety of sizes.

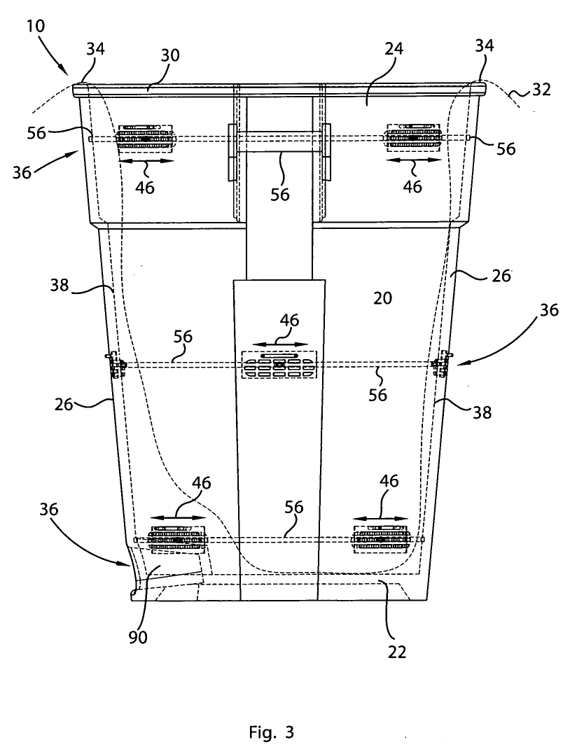

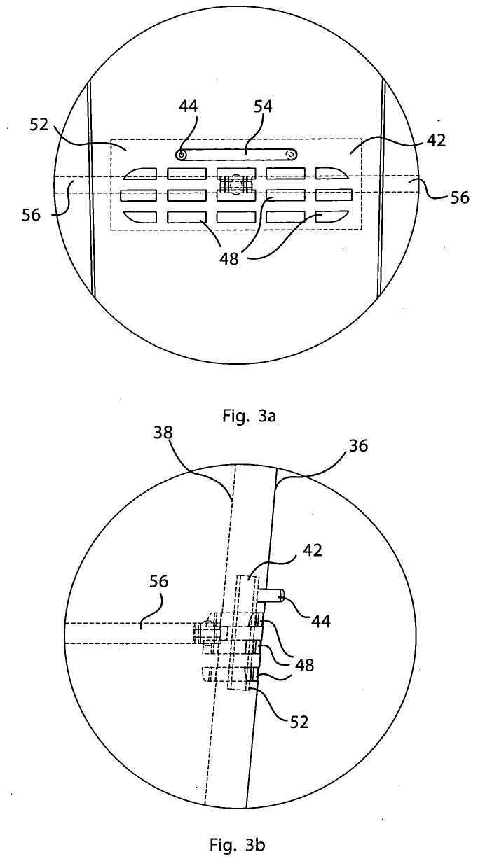

As perhaps best shown in FIG. 3, a collection bag 32 may be removably positioned within the cavity 28 in such a manner that a top edge 34 of the collection bag 32 remains continuously conjoined with the top rim 30 of the container 20. The bag 32 may fold over the top rim 30 of the container 20 and may be held in place by an air-flow regulating mechanism 36.

Mechanism 36 advantageously permits ambient air to freely ingress and egress through the outer surface 26, and thereby generates an external force that pushes inwardly against the collection bag 32 while seated within the cavity 28. The external force preferably maintains the collection bag 32 at a substantially stable position by assisting to prohibit the top edge 34 of the collection bag 32 from prematurely disengaging the top rim 30 as debris is deposited into the collection bag 32 and further by assisting to prohibit the collection bag 32 from undesirably clinging to an inner surface 38 of the container 20 during removal from the cavity 28. The incoming and outgoing air flow keeps bag 32 situated within the cavity 28 so bag 32 does not prematurely fall to the bottom of container 20. Further, no vacuum is created between bag 32 and container 20 so a user can swiftly remove bag 32 from container 20.

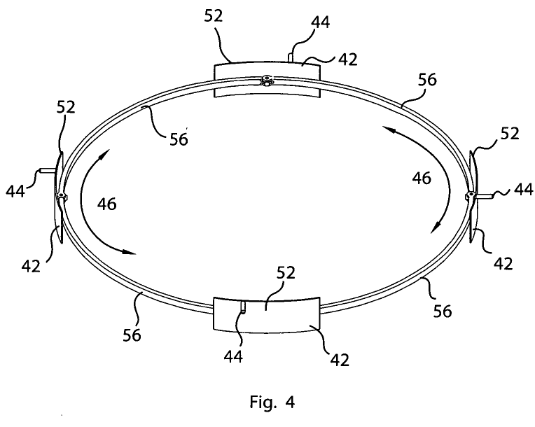

Referring again to FIGS. 1-4 as a whole, the ambient air ingressing and egressing mechanism 36 may include a plurality of vents 40 formed in the container 20 and passing from the outer surface 26 to the inner surface 38. The mechanism 36 may further include a plurality of access panels 42 slidably coupled to the vents 40 respectively, as perhaps best shown in FIGS. 3a-3b and 4. The access panels 42 preferably have a lever 44 statically mated thereto and terminating exterior of the outer surface 26 such that the levers 44 are accessible from an exterior of the container 20.

As perhaps best shown in FIG. 3, the access panels 42 may be configured in such a manner that vents 40 may be toggled between open and closed positions when the access panels 42 are reciprocating along corresponding travel paths 46 respectively. The travel paths 46 may be intercalated between the inner 38 and outer surfaces 26 of the container 20 such that the access panels are not exposed to inclement weather conditions. The access panels 42 may be opened or closed to assist in preventing the bag 32 from slipping off of the top rim 30, or assist in easily removing the bag 32 from the cavity 28 by adjusting the quantity of air flow into and out from the container 20.

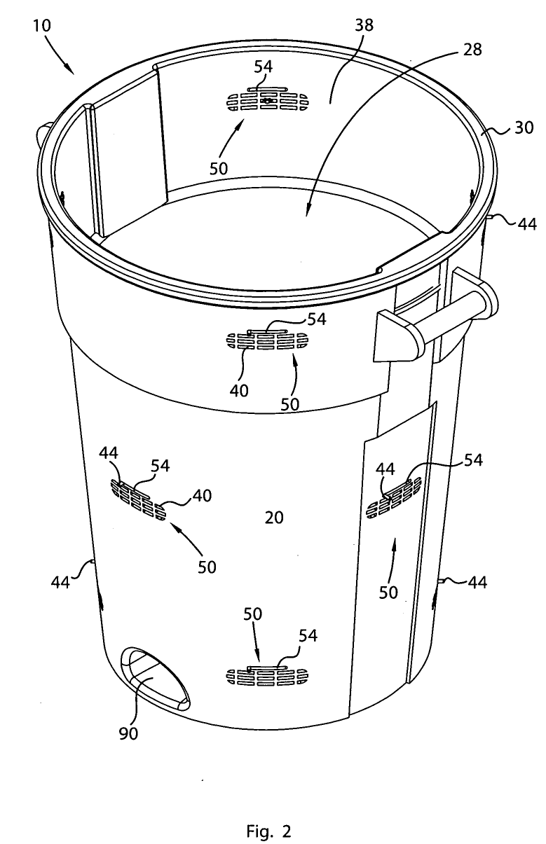

As perhaps best shown in FIG. 2-4, the vents 40 may include a plurality of apertures 48 separated into a plurality of separated clusters 50 spaced along the outer surface 26 of the container 20. A plurality of face plates 52 are preferably intercalated between the inner 38 and outer surfaces 26 of the container 20. The face plates 52 may be aligned with corresponding clusters 50 and further, may be anchored to the levers 44 respectively.

A plurality of rectilinear slots 54 formed in the container 20 may be adjoined to the clusters 50 respectively; wherein each of the levers 44 traverses a corresponding one of the slots 54 and remains spaced from the clusters 50 respectively. The travel paths 46 may be defined along associated longitudinal lengths of the slots 54 respectively so that air flows into and out from the container 20 in a generally concentrated manner, thereby reducing the likelihood of sporadically diffusing the air through the container 20.

FIGS. 1-4 show the ambient air ingressing and egressing mechanism 36 may further include a plurality of elongated arms 56 preferably having opposed ends directly and statically interconnected to adjacent ones of the access panels 42 respectively, such that the arms 56 are arranged at an end-to-end pattern along a circumference of the container 20. The arms 56 may be intercalated between the inner 38 and outer surfaces 26 of the container 20. Notably, arms 56 are pivotally coupled at the end-to-end connection such that each arm 56 is freely biased along a curvilinear path defined along a perimeter of the container 20. Such a pivoting arrangement permits the user to freely adapt the access panels 42 along mutually exclusive paths defined anterior of the clusters 50 during operating conditions.

Interconnected groups of the arms 56 and the levers 44 may uniformly shift along a curvilinear travel path 46 defined along the circumference of the container 20 when a first one of the levers 44 is displaced along one of the corresponding travel paths 46. This is achieved by freely positioning the arms 56 and access panels 42 between inner 38 and outer 26 walls. Thus, the interconnected ones of the access panels 42 uniformly shift in sync when the interconnected arms 56 shift in sync and thereby adapt the vents 40 between the open and closed positions respectively. Further, a lid 58 may be pivotally coupled to the top rim 30 of the container 20.

The present invention 10 may further include a method for using a vented container 20 and collection bag 32 apparatus during debris collecting, transporting and removal procedures. Such a method may include the chronological steps of first providing a portable container 20 that preferably has a closed bottom end 22 and an open top end 24. The container 20 further preferably has an outer surface 26 continuously spanning along a circumference of the container 20 such that a cavity 28 is formed intermediately of the bottom 22 and top ends 24. The top end 24 preferably has a top rim 30 continuously extending about an entire perimeter thereof.

A second step of the method may include providing and removably positioning a collection bag 32 within the cavity 28 in such a manner that a top edge 34 of the collection bag 32 remains continuously conjoined with the top rim 30 of the container 20. A third step may include permitting ambient air to freely ingress and egress through the outer surface 26, and thereby generating an external force that pushes inwardly against the collection bag 32 while seated within the cavity 28.

Lastly, the external force will maintain the collection bag 32 at a substantially stable position by assisting to prohibit the top edge 34 of the collection bag 32 from prematurely disengaging the top rim 30 as debris is deposited into the collection bag 32 and further by assisting to prohibit the collection bag 32 from undesirably clinging to an inner surface 38 of the container 20 during removal from the cavity 28.

The method and apparatus of the present invention provides an unpredictable benefit by making it easier to load debris into a garbage can as well as allowing a standard sized bag 32 to have increased usable capacity. The present invention also makes it easier to remove a bag 32 from the container 20 and thus place less strain on the user's muscles. The combination of mechanism 36 in use with collection bag 32 inside container 20 provides an unexpected result not rendered obvious by one skilled in the art.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. A combined vented container and collection bag for use during debris collecting, transporting and removal procedures, said combined vented container and collection bag comprising:
a container having a bottom end and an open top end, said container further having an outer surface spanning along a circumference of said container such that a cavity is formed intermediately of said bottom and top ends, said top end having a top rim extending about a perimeter thereof;
a collection bag positioned within said cavity in such a manner that a top edge of said collection bag remains continuously conjoined with said top rim of said container; and
means for permitting ambient air to freely ingress and egress through said outer surface and thereby generate an external force that pushes inwardly against said collection bag while seated within said cavity;
wherein said external force maintains said collection bag at a substantially stable position by assisting to prohibit said top edge of said collection bag from prematurely disengaging said top rim as debris is deposited into said collection bag and further by assisting to prohibit said collection bag from undesirably clinging to an inner surface of said container during removal from said cavity.

2. The combined vented container and collection bag of claim 1, wherein said ambient air ingressing and egressing means comprises:
a plurality of vents formed in said container and passing from said outer surface to said inner surface; and
a plurality of access panels slidably coupled to said vents respectively, each of said access panels having a lever statically mated thereto and terminating exterior of said outer surface such that said levers are accessible from an exterior of said container;
wherein said access panels are configured in such a manner that said vents are toggled between open and closed positions when said access panels are reciprocating along corresponding travel paths respectively;
wherein said travel paths are intercalated between said inner and outer surfaces of said container.

3. The combined vented container and collection bag of claim 2, wherein each of said vents comprises:
a plurality of apertures separated into a plurality of separated clusters spaced along said outer surface of said container;
a plurality of face plates intercalated between said inner and outer surfaces of said container, said face plates being aligned with corresponding ones said clusters and further being anchored to said levers respectively; and
a plurality of rectilinear slots formed in said container and being adjoined to said clusters respectively;
wherein each of said levers traverses a corresponding one of said slots and remains spaced from said clusters respectively.

4. The combined vented container and collection bag of claim 3, wherein said travel paths are defined along associated longitudinal lengths of said slots respectively.

5. The combined vented container and collection bag of claim 3, wherein said ambient air ingressing and egressing means further comprises:
a plurality of elongated arms having opposed ends directly and statically interconnected to adjacent ones of said access panels respectively such that said arms are arranged at an end-to-end pattern along a circumference of said container, said arms being intercalated between said inner and outer surfaces of said container;
wherein interconnected groups of said arms and said levers uniformly shift along a curvilinear travel path defined along the circumference of said container when a first one of said levers is displaced along one of said corresponding travel paths.

6. The combined vented container and collection bag of claim 5, wherein interconnected ones of said access panels uniformly shift in sync when said interconnected arms shift in sync and thereby adapt said vents between said open and closed positions respectively.

7. The combined vented container and collection bag of claim 1, further comprising: a lid pivotally coupled to said top rim of said container.

8. A combined vented container and collection bag for use during debris collecting, transporting and removal procedures, said combined vented container and collection bag comprising:
a portable container having a closed bottom end and an open top end, said container further having an outer surface continuously spanning along a circumference of said container such that a cavity is formed intermediately of said bottom and top ends, said top end having a top rim continuously extending about an entire perimeter thereof;
a collection bag removably positioned within said cavity in such a manner that a top edge of said collection bag remains continuously conjoined with said top rim of said container; and
means for permitting ambient air to freely ingress and egress through said outer surface and thereby generate an external force that pushes inwardly against said collection bag while seated within said cavity;
wherein said external force maintains said collection bag at a substantially stable position by assisting to prohibit said top edge of said collection bag from prematurely disengaging said top rim as debris is deposited into said collection, bag and further by assisting to prohibit said collection bag from undesirably clinging to an inner surface of said container during removal from said cavity.

9. The combined vented container and collection bag of claim 8, wherein said ambient air ingressing and egressing means comprises:
a plurality of vents formed in said container and passing from said outer surface to said inner surface; and
a plurality of access panels slidably coupled to said vents respectively, each of said access panels having a lever statically mated thereto and terminating exterior of said outer surface such that said levers are accessible from an exterior of said container;
wherein said access panels are configured in such a manner that said vents are toggled between open and closed positions when said access panels are reciprocating along corresponding travel paths respectively;
wherein said travel paths are intercalated between said inner and outer surfaces of said container.

10. The combined vented container and collection bag of claim 9, wherein each of said vents comprises:
a plurality of apertures separated into a plurality of separated clusters spaced along said outer surface of said container;
a plurality of face plates intercalated between said inner and outer surfaces of said container, said face plates being aligned with corresponding ones said clusters and further being anchored to said levers respectively; and
a plurality of rectilinear slots formed in said container and being adjoined to said clusters respectively;
wherein each of said levers traverses a corresponding one of said slots and remains spaced from said clusters respectively.

11. The combined vented container and collection bag of claim 10, wherein said travel paths are defined along associated longitudinal lengths of said slots respectively.

12. The combined vented container and collection bag of claim 10, wherein said ambient air ingressing and egressing means further comprises:
a plurality of elongated arms having opposed ends directly and statically interconnected to adjacent ones of said access panels respectively such that said arms are arranged at an end-to-end pattern along a circumference of said container, said arms being intercalated between said inner and outer surfaces of said container;
wherein interconnected groups of said arms and said levers uniformly shift along a curvilinear travel path defined along the circumference of said container when a first one of said levers is displaced along one of said corresponding travel paths.

13. The combined vented container and collection bag of claim 12, wherein interconnected ones of said access panels uniformly shift in sync when said interconnected arms shift in sync and thereby adapt said vents between said open and closed positions respectively.

14. The combined vented container and collection bag of claim 8, further comprising: a lid pivotally coupled to said top rim of said container.

15. A method for using a vented container and collection bag during debris collecting, transporting and removal procedures, said method comprising the chronological steps of:
a. providing a portable container having a closed bottom end and an open top end; said container further having an outer surface continuously spanning along a circumference of said container such that a cavity is formed intermediately of said bottom and top ends, said top end having a top rim continuously extending about an entire perimeter thereof;
b. providing and removably positioning a collection bag within said cavity in such a manner that a top edge of said collection bag remains continuously conjoined with said top rim of said container;
c. permitting ambient air to freely ingress and egress through said outer surface and thereby generating an external force that pushes inwardly against said collection bag while seated within said cavity; and
d. said external force maintaining said collection bag at a substantially stable position by assisting to prohibit said top edge of said collection bag from prematurely disengaging said top rim as debris is deposited into said collection bag and further by assisting to prohibit said collection bag from undesirably clinging to an inner surface of said container during removal from said cavity.
